(19) United States
(12) Patent Application Publication
(10) Pub. No.: US 2007/0100097 A1
(43) Pub. Date: May 3, 2007

(54) Method for the anionic polymerisation of oxiranes

(75) Inventors: Philippe Desbois, Maikammer (DE); Alain Deffieux, Bordeaux (FR); Stephane Carlotti, Pessac (FR); Cyrille Billouard, Mannheim (DE)

Correspondence Address: CONNOLLY BOVE LODGE & HUTZ, LLP, P O BOX 2207, WILMINGTON, DE, 19899, US

(73) Assignee: BASF AKTIENGESELLSCHAFT Patents, Trademarks and Licenses, Ludwigshafen (DE)

(21) Appl. No.: 10/557,838

(22) PCT Filed: May 10, 2004
(86) PCT No.: PCT/EP04/04956

§ 371 Date: Sep. 25, 2006

(30) Foreign Application Priority Data
May 20, 2003 (DE) 103 23 047.5

(51) Int. Cl. C08F 4/46

(52) U.S. Cl. 526/173; 526/266; 526/346; 526/335

(57) ABSTRACT

Process for preparing homopolymers of oxiranes, or for preparing copolymers of oxiranes and comonomers, via anionic polymerization in the presence of an alkali metal compound and of an organylaluminum compound, which comprises avoiding any use of crown ethers or of cryptands during the polymerization.

The invention relates to a process for preparing homopolymers of oxiranes, or for preparing copolymers of oxiranes and comonomers, via anionic polymerization in the presence of an alkali metal compound and of an organylaluminum compound, which comprises avoiding any use of crown ethers or of cryptands during the polymerization.

The invention further relates to the homopolymers of oxiranes, and copolymers (including block copolymers) of oxiranes and comonomers, these polymers being obtainable by the process, to the use of the homopolymers or copolymers for producing moldings, foils, fibers, or foams, and finally to the moldings, foils, fibers, and foams composed of the homopolymers or copolymers.

For the purposes of the present invention, oxiranes are epoxides of simple structure, for example ethylene oxide (EO), also termed oxirane, and propylene oxide (PO), also termed methyloxirane. See also CD Römpp Chemie Lexikon, Version 1.0, Thieme Verlag Stuttgart, 1995 (hereinafter referred to as Römpp), keyword “Oxirane”. Particular oxirane polymers which may be mentioned are polyethylene oxide (PEO) and polypropylene oxide (PPO).

PO polymers and EO polymers may be prepared, inter alia, via anionic polymerization. Initiator systems suitable for this purpose comprise, by way of example, aluminum porphyrins as initiator and bulky Lewis acids, such as isobutylaluminum bis(2,6-di-tertbutyl-4-methylphenolate)(=iBuAl(BHT)₂, BHT=butylhydroxytoluene) as coinitiator. However, the resultant polymers are not marketable because of the low molecular weight, pronounced intrinsic color, and the expensive initiator system.

Homopolymerization reactions of PO using other initiator systems are described in the following publications:

Ding et al., in Eur. Pol. J. 1991, 27, 891-894 and Eur. Pol. J, 1991, 27, 895-899, teach that the anionic polymerization of PO by means of the potassium salt of 1-methoxy-2-propanol is considerably accelerated (e.g. by a factor of 15) via concomitant use of a crown ether, such as 18-crown-6. The resultant PO homopolymers had number-average molecular weights of from about 3000 to 13 000.

JP-A 2000/086755 discloses an initiator composition composed of an alkali metal alkoxide (e.g. potassium tert-butanolate) or of an alkali metal hydroxide, of an organic Lewis acid, e.g. CH₃Al(BHT)₂, and of a crown ether, e.g. 18-crown-6. At 48 hours of reaction time, the number-average molecular weights (Mn) of the PPO are at most about 8000.

JP-A 2000/256457 teaches a similar initiator composition composed of an alkali metal alkoxide or alkali metal hydroxide, of a crown ether, and of specific organic Lewis acids, which have direct metal-carbon bonds without oxygen bridges. The number-average molecular weights of the PPO after from 5 to 25 hours of reaction time are at most about 10 000.

JP-A 2002/128886 discloses a similar initiator composition composed of an alkali metal alkoxide or alkali metal hydroxide, of a crown ether, of a trialkylaluminum compound, and of a polyether polyol. After 3 and, respectively, 6 days of polymerization time the number-average molecular weights of the PPO are about 25 000 and about 18 000.

All three of the JP publications teach that the crown ether is a significant constituent of the initiator system, because it encapsulates the alkali metal, and teach that at least 1 mol of crown ether is to be used per mole of alkali metal. A crown ether is used in all of the examples in the publications.

If, alongside the oxirane, use is made of another anionically polymerizable monomer, e.g. styrene, it is also possible to prepare oxirane copolymers, in particular block copolymers. Quirk et al., in Macromol. Chem. Phys. 2000, 201, 1395-1404, pp. 1396-1397 describe the preparation of polystyrene-PO block copolymers, by first using sec-butyllithium for the anionic polymerization of styrene. The polystyrene block is then functionalized using EO, and a PPO block is then polymerized onto the material in the presence of dimethyl sulfoxide (BMSO) and the potassium salt of tert-amyl alcohol. The reaction time is 7 days, and the number-average molecular weight of the block copolymer is about 5000.

Quirk et al., in Polym. Int. 1996, 39, 3-10 teach the preparation of polystyrene-EO block copolymers by a similar process, the potassium salt used being potassium tert-butanolate, potassium tert-amyl alcoholate, or potassium 2,6-di-tert-butylphenolate. After from 1 to 6 days of reaction time, block copolymers with number-average molecular weights of at most 19 000 were obtained.

The processes described for preparing homo- or copolymers of PO or of EO have very long polymerization times (two or more days) and/or the resultant molecular weights are unsatisfactorily low. They are therefore not cost-effective.

Ihara et al., in Macromolecules 2002, 35 No. 11, 21 May 2002, teach that tert-butyl acrylate, but not n-butyl acrylate or methyl methacrylate (MMA), can be polymerized anionically in the presence of an initiator system composed of potassium tert-butanolate and trialkylaluminum compounds, such as triisobutylaluminum (TIBA), to give the homopolymer. However, it is possible to polymerize a poly-MMA block onto a poly-tert-butyl acrylate block. No mention is made of oxiranes as monomers.

It is an object of the present invention to eliminate the disadvantages described. A particular object is to provide another process for polymerizing oxiranes. The process should have economic advantages over the known processes. The polymerization times should be markedly shorter than those in the prior-art processes, the desired polymerization time being at most 48 hours. This shorter time should not result in achievement of poorer molecular weight. Furthermore, the process should be capable of achieving polyoxiranes with higher molecular weights than those of the prior art. A further object consists in providing a process which can prepare not only homopolymers but also copolymers. Oxiranes are highly reactive compounds, and the process should permit improved monitoring and simpler control of the oxirane polymerization process. Finally, the process should be simpler than the processes of the prior art, in particular requiring fewer reagents.

We have found that this object is achieved by means of the process defined at the outset, and by means of the homo- and copolymers mentioned, the use mentioned for these, and the moldings, foils, fibers, or foams mentioned. Preferred embodiments of the invention are revealed in the subclaims.

The process of the invention polymerizes oxiranes via anionic polymerization to give homopolymers, or polymerizes oxiranes and comonomers via anionic polymerization to give copolymers. The polymerization takes place in the presence of an alkali metal compound and of an organylaluminum compound.

Suitable oxiranes are any of the epoxides of simple structure (i.e. without condensed ring systems). The oxiranes are preferably those selected from propylene oxide (PO), ethylene oxide (EO), and mixtures of these.

PO-EO copolymers are obtained if more than one oxirane is used together, in this case by way of example PO and EO. It has been found that the PO/EO mixtures polymerize in a manner similar to that of pure PO. This similar polymerization behavior means that some of the PO may be replaced by EO without any requirement for substantial change in the polymerization conditions (process parameters). This has economic advantages, because there is no need for complicated process adaptation measures. In addition, EO is generally less expensive than PO.

Suitable mixtures of PO and EO usually have an EO proportion of from 0.1 to 99.9% by weight, particularly from 10 to 90% by weight, and particularly preferably from 20 to 80% by weight, based on the mixture.

Comonomers which may be used to prepare the copolymers are any of the anionically polymerizable monomers, in particular styrene monomers and diene monomers. Suitable styrene monomers are any of the vinylaromatic monomers, for example styrene, α-methylstyrene, p-methylstyrene, ethylstyrene, tert-butylstyrene, vinylstyrene, vinyltoluene, 1,2-diphenylethylene, 1,1-diphenylethylene, or a mixture of these. Diene monomers which may be used are any of the polymerizable dienes, in particular 1,3-butadiene (abbreviated to butadiene), 1,3-pentadiene, 1,3-hexadiene, 2,3-dimethylbutadiene, isoprene, piperylene, or a mixture of these.

The comonomers have preferably been selected from styrene, α-methylstyrene, butadiene, isoprene, and mixtures of these. Styrene is particularly preferred.

If concomitant use is made of comonomers, i.e. if copolymers are prepared, the proportion of the comonomers is from 0.1 to 99.9% by weight, preferably from 0.1 to 80% by weight, and in particular from 0.1 to 50% by weight, based on the entire amount of monomer. Further details concerning the copolymers, in particular block copolymers, are given at a later stage below.

Suitable alkali metal compounds are any of the compounds which are an effective initiator, during the anionic polymerization process, in particular alkali metal hydrides and organyl compounds of alkali metals, a suitable alkali metal being, by way of example, lithium, sodium, or potassium.

Particular alkali metal hydrides which may be used are lithium hydride, sodium hydride, or potassium hydride.

For the purposes of the present invention, organyl compounds are the organometallic compounds of a metal having at least one metal-carbon α-bond, in particular the alkyl compounds or aryl compounds. The metal organyl compounds may also contain hydrogen or halogen, or may contain organic radicals bonded via heteroatoms, examples being alkoxide radicals or phenoxide radicals, on the metal. By way of example, the latter are obtainable via complete or partial hydrolysis, alcoholysis, or aminolysis.

Preferred organyl compounds of alkali metals are the alkoxides, hydroxides, amides, carboxy compounds, aryl compounds, arylalkyl compounds, and alkyl compounds of the alkali metals.

Suitable alkali metal alcoholates are those of alcohols having from 1 to 10 carbon atoms, for example the methanolates, ethanolates, n- and isopropanolates, n-, sec-, and tert-butanolates, and the pentanolates. The alcoholate radical may have substitution, e.g. with C₁-C₅-alkyl or halogen. Preferred alcoholates are the tert-amylates(=2-methyl-2-butanolates). Use is particularly preferably made of potassium tert-amylate, sodium tert-amylate, and sodium isopropanolate.

Examples of alkali metal hydroxides which may be used are lithium hydroxide, sodium hydroxide, or potassium hydroxide, in particular potassium hydroxide.

Examples of suitable alkali metal amides are the compounds M-NH₂. Alkali metal carboxylates R—COOM which may be used are those of carboxylic acids having from 1 to 10 carbon atoms. In both cases M=Li, Na, K.

By way of example, suitable alkali metal aryl compounds are phenyllithium and phenylpotassium, and the multifunctional compound 1,4-dilithiobenzene. Particularly suitable alkali metal arylalkyl compounds are alkali metal compounds of vinyl-substituted aromatics, in particular styrylpotassium and styrylsodium, M-CH═CH—C₆H₅, where M=K or Na. By way of example, they are obtainable by reacting the corresponding alkali metal hydride with styrene in the presence of an aluminum compound, such as TIBA. Oligomeric or polymeric compounds, such as polystyryllithium or -sodium are also suitable, being obtainable, by way of example, by mixing sec-butyllithium and styrene and then adding TIBA. Use may moreover also be made of diphenylhexyllithium or potassium.

Suitable alkali metal alkyl compounds are those of alkanes, of alkenes, and of alkynes having from 1 to 10 carbon atoms, examples being ethyl-, propyl-, isopropyl-, n-butyl-, sec-butyl-, tert-butyl-, hexamethylenedi-, butadienyl-, or isoprenyllithium, or the multifunctional compounds 1,4-dilithiobutane or 1,4-dilithio-2-butene. The alkali metal alkyl compounds are particularly well suited to the preparation of the oxirane copolymers: when preparing the block copolymers whose structure is composed of polyoxirane blocks and of blocks of the comonomer, they may advantageously be used in the polymerization of the comonomer block. By way of example, preferred use may be made of sec-butyllithium to polymerize the polystyrene block.

If the polymerization carried out takes the form of a solution polymerization, the selection of the alkali metal compound also depends on the solvent used. The selection of the alkali metal compound and solvent is preferably such that the alkali metal compound dissolves at least to some extent in the solvent.

In one preferred embodiment, resulting from the above, the alkali metal compound has been selected from alcoholates, hydrides, hydroxides, amides, carboxy compounds, aryl compounds, arylalkyl compounds, and alkyl compounds of the alkali metals, and mixtures of these. It is also possible, of course, to use different alkali metal compounds.

The preparation of the alkali metal compounds is known, or the compounds are commercially available.

The organylaluminum compounds are thought to act as activator. It is likely that they activate both the alkali metal compound and the oxirane. The organylaluminum compound is thought to improve the solubility of the alkali metal compound via complex formation. In the case of the oxirane, it is possible that the organylaluminum compound interacts with its epoxy group, opens the epoxy ring, and thus permits polymerization of the oxirane. It is likely that the mechanism differs fundamentally from that of the anionic polymerization of styrene or butadiene, where the organylaluminum compound is a “retarder” which reduces polymerization rate.

Organylaluminum compounds which may in particular be used are those of the formula R₃-Al, where the radicals R are, independently of one another, hydrogen, halogen, C₁₋₂₀-alkyl, C₆₋₂₀-aryl, or C₇₋₂₀-arylalkyl. Trialkylaluminum compounds are preferably used as organylaluminum compounds.

The alkyl radicals may be identical, as, for example, in trimethylaluminum (TMA), triethylaluminum (TEA), triisobutylaluminum (TIBA), tri-n-butylaluminum, triisopropylaluminum, tri-n-hexylaluminum, or different, as, for example, in ethyldiisobutylaluminum.

It is also possible to use dialkylaluminum compounds, such as diisobutylaluminum hydride (DiBAH).

Other organylaluminum compounds which may be used are those formed by partial or complete reaction of alkyl-, arylalkyl-, or arylaluminum compounds with water (hydrolysis), with alcohols (alcoholysis), with amines (aminolysis), or with oxygen (oxidation), or those which bear alcoholate, thiolate, amide, imide or phosphite groups.

Hydrolysis gives aluminoxanes. Examples of suitable aluminoxanes are methylaluminoxane, isobutylated methylaluminoxane, isobutylaluminoxane, and tetraisobutyldialuminoxane.

Alcoholysis gives aluminum alcoholates, also termed aluminum alkoxides (e.g. . . . propanolate= . . . propoxide). Examples of suitable alcoholates are dimethylaluminum ethanolate, diethylaluminum ethanolate, dimethylaluminum isopropanolate, dimethylaluminum n-butanolate, diisobutylaluminum ethanolate, diisobutylaluminum isopropanolate, diisobutylaluminum n-butanolate. Other suitable alcoholates are those of 2,6-di-tert-butyl-4-methylphenol, also termed butylhydroxytoluene (BHT), examples being methylaluminum bis(2,6-di-tert-butyl-4-methylphenolate)(=MeAl(BHT)₂), isobutylaluminum bis(2,6-di-tert-butyl-4-methylphenolate)(=iBuAl(BHT)₂), and diisobutylaluminum (2,6-di-tert-butyl-4-methylphenolate(=(iBu)₂AlBHT, CAS-No. 56252-56-3).

An example of a suitable aluminum amide is diethylaluminum N,N-dibutylamide. Oxidation gives aluminum oxides, such as bis(diisobutyl)aluminum oxide.

Depending on the molar ratio of alkylaluminum compound R₃Al to alcohol R′OH, one, two or all three, of the alkyl groups of the alkylaluminum compound are replaced by an alcoholate group (alkoxide group) during the alcoholysis reaction. Mixtures of various alcoholates R₂AlOR′, RAl(OR′)₂ and Al(OR′)₃ may also arise. The same principle applies to arylaluminums or arylalkylaluminum compounds, and for reaction partners other than alcohol. For example, the reaction of two different alkylaluminum compounds R₃Al and R₁₃Al gives compounds R₂AlR′ and RAlR′₂.

Reaction of alkylaluminum compounds with polyhydric alcohols, such as dialcohols, can give alcoholates having two or more Al atoms. For example, reaction of TIBA with 1,4-butanediol (HOnBuOH) gives an aluminum alcoholate iBuAlOnBuOAliBu, which may be used with preference.

Me is methyl, nBu is n-butyl, and iBu is isobutyl.

In one preferred embodiment, the organylaluminum compound used comprises trialkylaluminum compounds. In this embodiment, the trialkylaluminum compounds may be used as sole aluminum compound, or together with aluminoxanes, alcoholates, amides, and/or oxides of aluminum. This embodiment never uses aluminoxanes, alcoholates, amides, and/or oxides of aluminum alone, i.e. without trialkylaluminum compounds.

In one particularly preferred embodiment, TEA is used alone to prepare the homopolymers, or in particular TIBA is used alone, and TIBA alone, or ethyldiisobutylaluminum alone, is used to prepare the block copolymers.

In another, likewise particularly preferred embodiment, in addition to the trialkylaluminum compound concomitant use is made of an aluminum alcoholate, such as TIBA or TEA, and an alcoholate selected from dimethylaluminum isopropanolate, dimethylaluminum n-butanolate, diisobutylaluminum isopropanolate, diisobutylaluminum n-butanolate, and iBu₂AlOnBuOAliBu₂.

From what has been said it is apparent that it is also possible to use mixtures of various alkali metal compounds and, respectively, organylaluminum compounds. The following comments should be made concerning the amounts of alkali metal compound and organylaluminum compound:

The amount needed of alkali metal compound depends, inter alia, on the desired molecular weight (molar mass) of the polymer to be prepared, on the nature and amount of the organylaluminum compound used, and on the polymerization temperature. Use is generally made of from 0.0001 to 10 mol %, preferably from 0.0001 to 5 mol %, and particularly preferably from 0.0001 to 2 mol %, of alkali metal compound, based on the total amount of the monomers used.

As mentioned, the organylaluminum compound probably serves as activator of the alkali metal compound and of the oxirane. The required amount of organylaluminum compound therefore depends, inter alia, on the nature and amount of the monomer used, on the desired molecular weight (molar mass) of the polymer, on the nature and amount of the alkali metal compound used, and on the polymerization temperature.

The molar ratio of organylaluminum compound to alkali metal compound may vary within wide limits. It depends, by way of example, on polymerization rate, on the polymerization temperature, on the nature and amount (concentration) of the monomers used, and on the desired molecular weight of the polymer. The selection of the amounts of organylaluminum compound and alkali metal compound is preferably such that per mole of alkali metal in the reaction mixture there are from 1 to 100 mol of aluminum, i.e. the molar ratio of aluminum to alkali metal is preferably from 1:1 to 100:1. The molar ratio of aluminum to alkali metal is particularly preferably from 2:1 to 50:1, in particular from 4:1 to 10:1. By way of example, operations may be carried out with a ratio of about 5:1.

In one preferred embodiment, selection of the amount of organylaluminum compound is such that, based on the molar amount of the oxirane monomer, there are from 0.5 to 20 mol % of organylaluminum compound, calculated as aluminum atoms. Use is therefore preferably made of from 0.5 to 20 mol % of organylaluminum compound, calculated as aluminum atoms and based on the molar amount of the oxirane. It is particularly preferable to use from 1 to 5 mol % of organylaluminum compound.

Alkali metal compound and organylaluminum compound may be added together or separately, both in a chronological or spatial sense, batchwise all at once or in two or more portions, or else continuously. In particular when alkali metal hydrides are used as alkali metal compound, it is possible to premix organylaluminum compound and alkali metal hydride and to add this mixture, because the organylaluminum compound improves the solubility of the alkali metal hydride. If use is made of two or more alkali metal compounds or of two or more organylaluminum compounds, they may be added together or separately from one another, in a chronological or spatial sense.

Alkali metal compound and organylaluminum compound may be added undiluted or—preferably—in dissolved or dispersed (emulsified or suspended) form in a solvent or dispersion medium. It is possible—but not essential—here that this solvent or dispersion medium is identical with the solvent used during the polymerization reaction (see below).

During the polymerization reaction, concomitant use may be made of amine compounds which form a chelate, complexing the alkali metal atom. Use may in particular be made of tertiary amine compounds, such as N,N,N′,N′-tetramethylmethylenediamine (TMMDA), N,N,N′,N′-tetramethylethylenediamine (TMEDA), N,N,N′,N′-tetramethylpropylenediamine (TMPDA), N,N, N′,N′-tetramethylhexenediamine (TMHDA), and other N,N,N′,N′-tetraalkyldiamines, and also diazabicyclo[2.2.2]octane (DABCO). Among other suitable amines is pentamethyldiethylenetriamine.

According to the invention, the polymerization uses neither any crown ethers nor any cryptands. For the purposes of the present invention, crown ethers are macrocyclic polyethers. They generally have a planar structure and, by way of example, have ethylene bridges bonding their oxygen atoms. The term crown ethers also applies to those whose oxygen atoms have been completely or partially replaced by hetero atoms, such as N, P or S, and spherands, e.g. isocyclic carbon rings which bear —OH or bear other polar groups, all of which have identical orientation into the interior of a cavity. For the purposes of the present invention, cryptands are macropolycyclic azapolyethers related to the crown ethers and having two bridgehead nitrogen atoms bonded by bridges containing one or more oxygen atoms. For further details, see Römpp, key words “Kronenether” and “Kryptanden”.

In particular, no crown ethers or cryptands are used either as reagent or as ancillary material (e.g. solvent).

The omission of these (expensive) compounds makes the inventive process not only simpler than the prior-art processes but also more cost-effective in operation.

The polymerization reaction may be carried out in the absence of or—preferably—in the presence of a solvent. It is preferable for the solvent used to be non-polar and to contain no oxygen atoms or other heteroatoms which increase polarity. The polymerization reaction particularly preferably takes place in an aliphatic, isocyclic, or aromatic hydrocarbon or hydrocarbon mixture, for example benzene, toluene, ethylbenzene, xylene, cumene, hexane, heptane, octane, or cyclohexane. It is preferable to use solvents whose boiling point is above 70° C. It is particularly preferable to use heptane, toluene, or cyclohexane.

Once the polymerization reaction has ended, i.e. once the monomers have been consumed, it is terminated. During the polymerization reaction, and also after its termination, i.e. also after the monomers have been consumed, there are “living” polymer chains in the reaction mixture. The term “living” means that the polymerization reaction would immediately begin again on renewed addition of monomer, with no need for further addition of polymerization initiator. The reaction is finally terminated by adding a chain terminator (abbreviated to terminator). This terminator irreversibly terminates the living polymer chain ends.

Terminators which may be used are any of the protic substances, and Lewis acids. By way of example, water is suitable, as are C₁-C₁₀ alcohols, such as methanol, ethanol, isopropanol, n-propanol, and the butanols. Other suitable compounds are aliphatic and aromatic carboxylic acids, such as 2-ethylhexanoic acid, and also phenols. It is also possible to use inorganic acids, such as carbonic acid (solution of CO₂ in water) and boric acid. Ethanol is preferably used as terminator.

The resultant reaction mixture may, if desired, then be worked up in a known manner to give the polymer, e.g. by means of devolatilization in a vented extruder or evaporator. The devolatilization removes oligomers which have formed and residual monomers, and also removes volatile auxiliaries and ancillary materials used during the polymerization reaction, and in particular the solvent.

The reaction conditions, such as pressure and temperature, depend, inter alia, on the reactivity and concentration of the monomers, on the alkali metal compounds and aluminum compounds used, and on their concentrations. Operations are usually carried out at an absolute pressure of from 0.1 to 10 bar, in particular from 0.5 to 5 bar, and particularly preferably at atmospheric pressure, and at a reaction temperature from −50 to 200° C., in particular from −30 to 100° C., and particularly preferably from −10 to 30° C. Low temperatures permit better control of the reaction, but the polymerization time is longer. The polymerization reaction usually takes from 5 min to 48 hours, in particular from 10 min to 12 hours.

The inventive process for preparing the polymers may be carried out batchwise or continuously, in any conventional container or reactor, and in principle it is possible to use either back-mixing or non-back-mixing reactors (i.e. reactors with stirred-tank characteristics or tubular-reactor characteristics). Depending on the selection of the alkali metal compound and of the organylaluminum compound, and of the concentrations of these, and of the specific procedure used (e.g. sequence of addition), and of other parameters, such as polymerization time and polymerization temperature and, if appropriate, temperature profile, the process gives polymers of various molecular weight. By way of example, stirred tanks are suitable, as are tower reactors, loop reactors, and also tubular reactors or tube-bundle reactors, with or without internals. Internals may be static or movable internals.

Besides the polymerization process described above, the invention also provides the polymers obtainable by the polymerization process, i.e. homopolymers of oxiranes, or copolymers of oxiranes and comonomers, or a mixture of these.

These oxirane homopolymers are in particular polyethylene oxide and polypropylene oxide. The number-average molar mass Mn of the polyethylene oxide (PEO) or polypropylene oxide (PPO) obtained is in each case preferably from 5000 to 1 000 000 g/mol, in particular from 10 000 to 500 000 g/mol, and particularly preferably from 20 000 to 200 000 g/mol.

The copolymers obtained may have a random structure, meaning that the sequence of the monomer units in the copolymer is entirely random, or an alternating structure (where oxirane units and comonomer units alternate). They may also have a tapered structure. The term “tapered” means that a gradient from oxirane-rich to oxirane-poor or vice versa is present along the polymer chain.

However, the copolymers preferably have a block structure, and are therefore block copolymers. The structure of the block copolymers is preferably composed of at least one block of the oxirane(s), and of at least one block of the comonomer(s).

The inventive block copolymers may, by way of example, be linear two-block copolymers A-B or three-block copolymers B-A-B or A-B-A. A here is the polyoxirane block and B here is the block composed of comonomer(s). For styrene as preferred comonomer, B is therefore a polystyrene block.

The block structure arises essentially because the comonomer is first anionically polymerized alone, producing a “living” block composed of the comonomers. Once the comonomers have been consumed, the monomer is changed by adding monomeric oxirane and polymerizing anionically to give an oxirane block, meaning that an oxirane block is polymerized onto the living comonomer block. By way of example, styrene may first be polymerized alone to give a polystyrene block PS. Once the styrene has been consumed, the monomer is changed by adding propylene oxide, which then is polymerized to give the polypropylene oxide block PPO. The result of this polymerization, known as sequential polymerizaiton, is a two-block polymer B-A, e.g. PS—PPO.

It is also possible to begin by preparing the polyoxirane block A and then to polymerize, onto this, the block B composed of the comonomer(s). However, it is preferable to polymerize the comonomer block B first and then the polyoxirane block A, for example the polystyrene block first and then the PPO block.

The invention therefore also provides a process wherein the copolymers are block copolymers, sequential polymerization being used, first polymerizing the comonomer to give a polymer block B and then polymerizing the oxirane to give a polyoxirane block A.

From the two-block polymers, it is possible to prepare three-block copolymers via coupling, using another living polymer block. For this, a living polymer block is first prepared separately and then coupled to the two-block copolymer, using a coupling agent (see below). Three-block copolymers may also be prepared by means of a telechelic middle block. For example, two terminal PPO blocks may be polymerized onto a telechelic polystyrene block, giving a three-block copolymer PPO—PS—PPO. The two comonomer blocks (e.g. polystyrene blocks) in the three-block copolymers may be of equal size (equal molecular weight, i.e. symmetrical structure) or be of different size (different molecular weight, i.e. asymmetric structure). The block sizes depend, by way of example, on the amounts of monomer used and the polymerization conditions.

In preparing the block copolymers, the alkali metal compound or the organylaluminum compound may be added before polymerization of the first block is complete. However, in particular if—as is preferred—the comonomer block is prepared first and then the polyoxirane block, the comonomer block may be polymerized in the presence of the alkali metal compound (i.e. without organylaluminum compound), the addition of the organylaluminum compound being delayed until the polymerization of the polyoxirane block has begun.

By way of example, the polystyrene block may first be prepared from styrene by means of an alkali metal compound (e.g. sec-butyllithium), and the addition of the organylaluminum compound (e.g. TIBA) may be delayed until the addition of the oxirane monomer has begun, followed by polymerization to give the polyoxirane block.

In a particularly preferred method—after the comonomer block has been prepared the oxirane monomer is first added, and once the reaction has started, this sometimes being visible from the color of the reaction mixture, the organylaluminum compound is added.

When preparing the block copolymers, it is preferable that at least the oxirane monomer is polymerized with a molar excess of aluminum over alkali metal. In particular, at least during the polymerization of the polyoxirane block A, the molar ratio of aluminum to alkali metal is from 1:1 to 100:1.

The block copolymers mentioned may have a linear structure (as described above). However, branched or star structures are also possible and are preferred for some applications. Branched copolymers are obtained in a known manner, e.g. via graft reactions of polymeric “branches” onto a main polymer chain.

Star-block copolymers or three-block copolymers are formed, by way of example, via reaction of the living anionic chain ends with an at least bifunctional coupling agent. These coupling agents are described, by way of example, in U.S. Pat. Nos. 3,985,830, 3,280,084, 3,637,554, and 4,091,053. Preference is given to epoxidized glycerides (e.g. epoxidized linseed oil or soy oil), silicon halides, such as SiCl₄, or else divinylbenzene, or else polyfunctional aldehydes, ketones, esters, anhydrides, or epoxides. Specifically for dimerization, other suitable compounds are dichlorodialkylsilanes, dialdehydes, such as terephthal aldehyde, and esters, such as ethyl formate. Symmetrical or asymmetric star structures can be prepared via coupling of identical or different polymer chains, and this means that the individual arms of the star may be identical or different, and in particular may contain different blocks or different block sequences.

The inventive polymers may also comprise conventional additives and processing aids, the amounts being those usual for these substances, examples being lubricants, moldrelease agents, colorants, e.g. pigments or dyes, flame retardants, antioxidants, light stabilizers, fibrous or pulverulent fillers, fibrous or pulverulent reinforcing agents, and antistatic agents, and also other additives and mixtures of these.

The molding compositions may be prepared by mixing processes known per se, for example with melting in an extruder, Banbury mixer, or kneader, or on a roll mill or calender. However, the components may also be used “cold”, and the melting and homogenization of the mixture, composed of powder or of pellets, may be delayed until processing has begun.

The inventive homo- and copolymers may be used to produce moldings (or semifinished products), foils, fibers, or foams of any type.

The invention accordingly also provides for the use of the inventive homo- or copolymers for producing moldings, foils, fibers and foams and also the moldings, foils, fibers and foams obtainable from the polymers.

The inventive process is an alternative process for the polymerization of oxiranes, and, when compared with the prior-art processes, has, inter alia, economic advantages. The polymerization times are markedly shorter than in the processes known hitherto. At the same time, despite the shorter polymerization time, the molar masses achieved are higher, for example as shown in example H10 with an Mn of 69 900 g/mol after only 6 hours.

The process permits the preparation of homo- and copolymers in similarly simple fashion. The polymers obtained feature low residual monomer contents and low residual oligomer contents. In addition, it is possible to prepare PO homopolymers and PO-EO copolymers under similar process conditions, and this is economically advantageous because EO is less expensive.

The process of the invention permits better monitoring of the oxirane polymerization reaction, and this means that the polymerization of the reactive oxiranes can be controlled in a simple manner.

### EXAMPLES

1. Starting Materials

Use was made of the compounds specified in 1a and 1b, “purified” meaning that, unless otherwise stated, aluminoxanes were used to purify and dry the material. In the case of commercial products, the item number or order number is stated after #. Commercial products were used without further purification.

1a. Monomers, Solvents, and Auxiliaries

Styrene, purified
Propylene oxide (PO), purified using calcium hydride
Heptane, purified
Cyclohexane, purified
Toluene, purified
Tetrahydrofuran (THF), purified
Ethanol (as terminator)
N,N,N′,N′-Tetramethylethylenediamine (TMEDA) from Aldrich (#41,101-9), redistilled grade >99.5%.
   1b. Alkali Metal Compounds and Organylaluminum Compounds

The organylaluminum compounds and alkali metal compounds were used in the form of solutions. Some of the solutions were obtained via reaction of appropriate starting solutions. Unless otherwise stated, all of the dilution or reaction processes were undertaken with stirring, at 25° C. and under inert gas. The following solutions S1 to S17 were used:
S1: Triisobutylaluminum (TIBA) in the form of a 1.0 molar solution in toluene (ready-to-use solution from Aldrich, #19,271-6)
S2: Triethylaluminum (TEA) 1.0 molar:
   A 1.9 molar triethylaluminum solution in toluene (ready-to-use solution from Aldrich, #25,718-4) was diluted with toluene to a concentration of 1 mol/l.
S3: Potassium tert-amyl alcoholate (tAmOK)=potassium 2-methyl-2-butanolate, in the form of a 0.78 molar solution in cyclohexane:
   1 g of comminuted potassium metal was briefly washed with ethanol, rinsed in toluene, and treated in vacuo with 23 ml of cyclohexane. 2.1 ml of 2-methylbutan-2-ol were added, and the mixture was then held for 3 days at 80° C. The resultant solution of potassium tert-amyl alcoholate in cyclohexane was 0.78 molar.
S4: Sodium tert-amyl alcoholate (tAmONa)=sodium 2-methyl-2-butanolate, in the form of a 0.75 molar solution in cyclohexane:
   The procedure was as described for S3, but 1 g of sodium metal was used instead of 1 g of potassium metal. The resultant solution of sodium tert-amyl alcoholate in cyclohexane was 0.75 molar.
S5: Solution of dimethylaluminum isopropanolate (iPrOAlMe₂) and sodium tert-amyl alcoholate, in each case 0.52 molar:
   A 2.0 molar solution of trimethylaluminum (TMA) in toluene (ready-to-use solution from Aldrich, #25,723-0) was diluted with toluene to 0.2 mol/l. To this 0.2 molar TMA solution, sufficient isopropanol (>99.5%, anhydrous, Aldrich, #27,847-5) was added to give an isopropanol/AI molar ratio of 1:3. A solution S5a of dimethylaluminum isopropanolate was obtained. This solution S5a was then mixed with sufficient sodium tert-amyl alcoholate solution S4 and diluted with toluene to give concentrations of in each case 0.52 mol/l of dimethylaluminum isopropanolate and of sodium tert-amyl alcoholate.
S6: Solution of dimethylaluminum n-butanolate (nBuOAlMe₂) and sodium tert-amyl alcoholate, in each case 0.52 molar:
   A 2.0 molar solution of trimethylaluminum (TMA) in toluene (ready-to-use solution from Aldrich, #25,723-0) was diluted with toluene to 0.2 mol/l. To this 0.2 molar TMA solution, sufficient n-butanol (>99.9%, anhydrous, Aldrich, #28,154-9) was added to give an n-butanol/Al molar ratio of 1:3. A solution S6a of dimethylaluminum n-butanolate was obtained. This solution S6a was then mixed with sufficient sodium tert-amyl alcoholate solution S4 and diluted with toluene to give concentrations of in each case 0.52 mol/l of dimethylaluminum n-butanolate and of sodium tert-amyl alcoholate.
S7: Solution of iBu₂AlOnBuOAliBu₂, 0.13 molar, and sodium tert-amyl alcoholate, 0.52 molar:
   The 1.0 molar TIBA solution S1 was diluted with toluene to 0.1 mol/l. To this 0.1 molar TIBA solution, sufficient 1,4-butanediol (>99%, anhydrous, Aldrich, #24,055-9) was added to give a 1,4-butanediol/Al molar ratio of 1:6. This gave a solution S7a of iBu₂AlOnBuOAliBu₂. This solution S7a was then mixed with sufficient sodium tert-amyl alcoholate solution S4, and diluted with toluene, to give a 0.13 mol/l concentration of iBu₂AlOnBuOAliBu₂ (i.e. 0.26 mol/l of Al) and a concentration of 0.52 mol/l of sodium tert-amyl alcoholate.
S8: Solution of triisobutylaluminum (TIBA), 0.516 molar, and potassium hydroxide (KOH), 0.258 molar:
   To the 1.0 molar TIBA solution S1, sufficient potassium hydroxide was added to give an Al/K molar ratio of 2:1. The resultant TIBA-KOH solution was diluted with toluene to give a 0.516 mol/l concentration of TIBA and a 0.258 mol/l concentration of potassium hydroxide.
S9: Solution of triisobutylaluminum (TIBA), 1.0 molar, and sodium hydride (NaH), 0.202 molar:
   To the 1.0 molar TIBA solution S1, sufficient solid sodium hydride was added to give a 1.0 mol/l concentration of TIBA and a 0.202 mol/l concentration of sodium hydride.
S10: Solution of triisobutylaluminum (TIBA), 1.0 molar, and lithium hydride (LiH), 0.202 molar:
   To the 1.0 molar TIBA solution S1, sufficient solid lithium hydride was added to give a 1.0 mol/l concentration of TIBA and a 0.202 mol/l concentration of lithium hydride.
S11: Solution of triisobutylaluminum (TIBA), 1.0 molar, and sodium hydride (NaH), 0.98 molar:
   To the 1.0 molar TIBA solution S1, sufficient solid sodium hydride was added to give a 1.0 mol/l concentration of TIBA and a 0.98 mol/l concentration of sodium hydride.
S12: Sodium isopropanolate (iPrONa) in the form of a 1.306 molar solution in tetrahydrofuran:
   1 g of comminuted sodium metal was briefly washed with ethanol, rinsed in toluene, and treated in vacuo with 19 ml of tetrahydrofuran. After addition of 2 ml of isopropanol, the mixture was held for 3 days at 50° C. The resultant solution of sodium isopropanolate in tetrahydrofuran was 1.306 molar.
S13: sec-Butyllithium (sBuLi) in the form of a 1.3 molar solution in toluene (ready-to-use solution from Aldrich, #19,559-6)
S14: Solution of triisobutylaluminum (TIBA), 0.135 molar, and sodium hydride (NaH), 0.15 molar:
   To the 1.0 molar TIBA solution S1, sufficient solid sodium hydride was added to give an Al/Na molar ratio of 0.9. The resultant TIBA-NaH solution was diluted with toluene to give a 0.135 mol/l concentration of TIBA and a 0.15 mol/l concentration of sodium hydride.
S15: Ethyldiisobutylaluminum (EtAliBU₂), 0.482 molar:
   To the TIBA solution S1, sufficient of the TEA solution S2 was added to give a TIBA/TEA molar ratio of 2:1. This gave a 0.482 molar solution of ethyldiisobutylaluminum.
S16: Diethylzinc (Et₂Zn), 0.482 molar
   A 1.1 molar diethylzinc solution in toluene (ready-to-use solution from Aldrich, #22,080-9) was diluted with toluene to a concentration of 0.482 mol/l.
S17: Triethylboron (Et₃B), 0.482 molar
   A 1.0 molar triethylboron solution in hexane (ready-to-use solution from Aldrich, #19,503-0) was diluted with toluene to a concentration of 0.482 mol/l.
      2. Preparation of Polymers

All of the polymerization reactions were carried out in a glove box under nitrogen with exclusion of moisture. A round-bottomed flask with magnetic stirrer and a septum and temperature control was used. During the polymerization reaction, the mixture was stirred and the fall-off in monomer concentration was followed gravimetrically. The polymerization was terminated by adding 10 ml of ethanol.

The molecular weights and molecular weight distributions in the resultant polymer mixture were determined by gel permeation chromatography (GPC) using tetrahydrofuran as eluent and polystyrene standards for calibration. The number-average molecular weight Mn and the weight-average molecular weight Mw were used to determine the polydispersity index PDI=Mw/Mn.

“GPC peak” refers to the chromatogram obtained during GPC, and “integral” is the integral over all of the peaks. The molar masses are stated in g/mol.

2a. Preparation of PO Homopolymers H

### Example H1

8 ml of PO were added to 14 ml of heptane. 0.3 ml of the solution S3 (tAmOK) and 1.2 ml of the solution S1 (TIBA) were added, the Al/K ratio thus being 5:1. The mixture as polymerized at 0° C. for 15 hours, and the polymerization was then terminated. The results were as follows: conversion 99%, polydispersity index PDI 1.5, number-average molar mass Mn 20 800.

### Example H2

5 ml of PO were added to 5 ml of cyclohexane. 0.2 ml of the solution S4 (tAmONa) and 0.75 ml of the solution S1 (TIBA) were then added, the Al/Na molar ratio thus being 5:1. The mixture was polymerized at 20° C. for 25 min, and the polymerization was then terminated. The results were as follows: conversion 100%, polydispersity index PDI 2.0, number-average molar mass Mn 15 100.

### Comparative Example C1

5 ml of PO were added to 6 ml of heptane. 0.2 ml of the solution S3 (tAmOK) were then added, but no organylaluminum compound was added. The mixture was polymerized at 0° C. for 19 hours, and the polymerization was then terminated. The results were as follows: conversion 0.5%, number-average molar mass Mn smaller than 1000.

### Example H3

7 ml of PO were added to 7 ml of toluene. 0.49 ml of the solution S5 (iPrOAlMe₂ and tAmONa) and 1.01 ml of the solution S1 (TIBA) were added, the Al/Na molar ratio thus being 5:1. The mixture was polymerized at 20° C. for 15 hours, and the polymerization was then terminated. The results were as follows: conversion 34%, polydispersity index PDI 1.7, number-average molar mass Mn 7600.

### Example H4

7 ml of PO were added to 7 ml of toluene. 0.3 ml of the solution S6 (nBuOAlMe₂ and tAmONa) and 0.62 ml of the solution S1 (TIBA) were added, the Al/Na molar ratio thus being 5:1. The mixture was polymerized at 20° C. for 100 min, and the polymerization was then terminated. The results were as follows: conversion 43%, polydispersity index PDI 1.9, number-average molar mass Mn 15 600.

### Example H5

7 ml of PO were added to 7 ml of toluene. 0.3 ml of the solution S7 (iBu₂AlOnBuOAliBu₂ and tAmONa) and 0.70 ml of the solution S1 (TIBA) were added, the Al/Na molar ratio thus being 5:1. The mixture was polymerized at 20° C. for 180 min, and the polymerization was then terminated. The results were as follows: conversion 98%, polydispersity index PDI 1.6, number-average molar mass Mn 18 700.

### Example H6

0.5 ml of the solution S8 (TIBA and KOH) and 0.38 ml of the solution S1 (TIBA) were added to 3 ml of cyclohexane, the Al/K molar ratio thus being 5:1. 3.4 ml of PO were added after 10 min. The mixture was polymerized at 20° C. for 3 hours, and the polymerization was then terminated. The results were as follows: conversion 99%, polydispersity index PDI 2.2, number-average molar mass Mn 12 500.

### Example H7

0.4 ml of solution S9 (TIBA and NaH) were added to 3 ml of toluene, the Al/Na molar ratio thus being 5:1. 3 ml of PO were added after 10 min. The mixture was polymerized at 20° C. for 50 min, and the polymerization was then terminated. The results were as follows: conversion 96%, polydispersity index PDI 1.6, number-average molar mass Mn 18 200.

### Example H8

1.2 ml of solution S10 (TIBA and L1H) were added to 3 ml of toluene, the Al/Li molar ratio thus being 5:1. 3 ml of PO were added after 10 min. The mixture was polymerized at 0° C. for 15 min, and the polymerization was then terminated. The results were as follows: conversion 96%, polydispersity index PDI 1.5, number-average molar mass Mn 9000.

### Example H9

a) 0.54 ml of styrene was added to 3.5 ml of the solution S11 (TIBA and NaH), and the reaction mixture was kept at 70° C. for 48 hours. This gave a solution of styrylsodium (StyNa) and TIBA.

b) 5 ml of PO were added to 5 ml of cyclohexane. 0.8 ml of the solution S1 (TIBA) and 0.2 ml of the solution obtained in a) (StyNa and TIBA) were added, the Al/Na molar ratio thus being 5:1. The mixture was polymerized at 20° C. for 75 min, and the polymerization was then terminated. The results were as follows: conversion 99%, polydispersity index PDI 1.6, number-average molar mass Mn 16 300.

### Example H10

7 ml of PO were added to 20 ml of cyclohexane. 0.04 ml of the solution S12 (iPrONa) and 2 ml of the solution S1 (TIBA) were added, the Al/Na molar ratio thus being 38:1. The mixture was polymerized at 0° C. for 6 hours, and the polymerization was then terminated. The results were as follows: conversion 99%, polydispersity index PDI 1.25, number-average molar mass Mn 69 900.

### Example H11

1 ml of PO was added to 20 ml of cyclohexane. 0.04 ml of the solution S12 (iPrONa) and 0.26 ml of the solution S1 (TIBA) were then added, the Al/Na molar ratio thus being 5:1. The mixture was polymerized at 0° C. for 60 min, and the polymerization was then terminated. The results were as follows: conversion 93%, polydispersity index PDI 1.13, number-average molar mass Mn 22 600.

### Example H12

1 ml of PO was added to 20 ml of cyclohexane. 0.04 ml of the solution S12 (iPrONa) and 0.26 ml of the solution S2 (TEA) were added, the Al/Na molar ratio thus being 5:1. The mixture was polymerized at 0° C. for 60 min, and the polymerization was then terminated. The results were as follows: conversion 17%, polydispersity index PDI 1.22, number-average molar mass Mn 2500.

### Example H13

1 ml of PO was added to 20 ml of cyclohexane. 0.04 ml of the solution S12 (iPrONa) and 0.26 ml of the solution S2 (TEA), and also 0.03 g of TEMDA, were added, the Al/Na molar ratio thus being 5:1. The mixture was polymerized at 0° C. for 2 hours, and the polymerization was then terminated. The results were as follows: conversion 12%, polydispersity index PDI 1.15, number-average molar mass Mn 1900.

### Comparative Example Comp. 2

The procedure was as in Example H1, but 0.3 ml of the solution S13 (sBuLi) was used instead of solution S3 (tAmOK), and no organylaluminum compound was used. The polymerization was terminated after 7 days. The results were as follows: conversion 0.5%; number-average molar mass Mn smaller than 1000.

### Comparative Example Comp. 3

The procedure was as in Example H1, but potassium hydroxide was used instead of solution S3 (tAmOK), and no organylaluminum compound was used. The polymerization was terminated after 7 days. The results were as follows: conversion 11%; number-average molar mass Mn 3400.

### Comparative Example Comp. 4

The procedure was as in Example H1, but 0.3 ml of the solution S12 (iPrONa) was used instead of solution S3 (tAmOK), and no organylaluminum compound was used. The polymerization was terminated after 7 days. The results were as follows: conversion 0.5%; number-average molar mass Mn smaller than 1000.

2b. Preparation of PO Block Copolymers C

### Example C1

a) 3 ml of styrene were added to 2 ml of the solution S14 (TIBA and NaH), and the mixture was polymerized at 100° C. for 12 hours. The resultant polystyrene block (polystyrylsodium, PSNa), had a polydispersity index PDI of 1.4 and a number-average molar mass Mn of 9 100.

b) 5 ml of PO were added to 5 ml of toluene. 1.2 ml of the solution S1 (TIBA) and 5 ml of the solution (PSNa) obtained in a) were added, the Al/Na molar ratio thus being 5:1. The mixture was polymerized at 0° C. for 60 min and then at 20° C. for a further 10 min, and the polymerization was then terminated. The results for the PS—PPO block copolymer obtained were as follows: conversion 26%, polydispersity index PDI 3.8, number-average molar mass Mn 19 400.

### Example C2

a) 3.5 ml of styrene were added to 14 ml of cyclohexane. 1.25 ml of the solution S13 (sBuLi) were added to the mixture, which was polymerized at 0° C. for 2 hours. The polystyrene block obtained (polystyryllithium, PSLi) had a polydispersity index PDI of 1.1 and a number-average molar mass Mn of 1700.

b) 1.75 ml of the solution S1 (TIBA) and 4 ml of the solution (PSLi) obtained in a) were added to 6 ml of PO, the Al/Li molar ratio therefore being 5:1. The mixture was polymerized at 0° C. for 60 min and then at 20° C. for 15 hours, and the polymerization was then terminated. The results for the PS—PPO block copolymer obtained were as follows: conversion 98%, polydispersity index PDI 1.7, number-average molar mass Mn 7700. A second GPC peak with less than 5% of the integral was attributed to the PSLi.

### Example C3

a) 10.7 ml of styrene were added to 6.8 ml of cyclohexane. 1.3 ml of the solution S13 (sBuLi) were added to the mixture, which was polymerized at 0° C. for 2 hours. The polystyrene block obtained (polystyryllithium, PSLi) had a polydispersity index PDI of 1.1 and a number-average molar mass Mn of 4700.

b) 6 ml of PO were added to 3.8 ml of the solution (PSLi) obtained in a). Once the color of the solution had changed, 1.75 ml of the solution S1 (TIBA) were added, the Al/Li molar ratio thus being 5:1. The mixture was polymerized at 0° C. for 60 min and then at 20° C. for 13 hours, and the polymerization was then terminated. The results for the PS—PPO block copolymer obtained were as follows: conversion 99%, polydispersity index PDI 1.5, number-average molar mass Mn 8000. A second GPC peak with about 40% of integral was attributed to the PSLi.

### Example C4

a) 3 ml of styrene were added to 10 ml of cyclohexane. 9.2 ml of the solution S13 (sBuLi) were added to the mixture, which was polymerized at 0° C. for 2 hours. The polystyrene block obtained (polystyryllithium, PSLi) had a polydispersity index PDI of 1.16 and a number-average molar mass Mn of 10 600.

b) 4 ml of PO and 4 ml of cyclohexane were added to 7.2 ml of the solution (PSLi) obtained in a). Once the color of the solution had changed, 0.71 ml of the solution S1 (Tl-BA) were added, the Al/Li molar ratio thus being 5:1. The mixture was polymerized at 0° C. for 60 min and then at 20° C. for a further 47 hours, and the polymerization was then terminated. The results for the PS—PPO block copolymer obtained were as follows: conversion 94%, polydispersity index PDI 1.4, number-average molar mass Mn 30 800. A second GPC peak with about 30% of integral was attributed to the PSLi.

### Example C5

a) 0.56 ml of styrene were added to 12.5 ml of cyclohexane. 0.2 ml of the solution S13 (sBuLi) were added to the mixture, which was polymerized at 0° C. for 2 hours. The polystyrene block obtained (polystyryllithium, PSLi) had a polydispersity index PDI of 1.16 and a number-average molar mass Mn of 1950.

b) 4 ml of PO and 4 ml of cyclohexane were added to 10.8 ml of the solution (PSLi) obtained in a). Once the color of the solution had changed, 2.66 ml of the solution S15 (EtAliBu₂) were added, the Al/Li molar ratio thus being 9:1. The mixture was polymerized at 0° C. for 60 min and then at 20° C. for a further 2 hours, and the polymerization was then terminated. The results for the PS—PPO block copolymer obtained were as follows: conversion 99%, polydispersity index PDI 1.9, number-average molar mass Mn 3700. A second GPC peak with about 30% of integral was attributed to the PSLi.

### Example C6

a) 2.5 ml of styrene were added to 5.2 ml of toluene. 0.9 ml of the solution S13 (sBuLi) were added to this mixture, which was polymerized at 0° C. for 2 hours. The polystyrene block obtained (polystyryllithium, PSLi) had a polydispersity index PDI of 1.1 and a number-average molar mass Mn of 2200.

b) 2.5 ml of PO were added to 1 ml of the solution (PSLi) obtained in a). Once the color of the solution had changed, 0.29 ml of the solution S15 (EtAliBu₂) and 0.53 ml of the solution S2 (TEA) were added to the mixture, the Al/Li molar ratio thus being 5:1. The mixture was polymerized at 0° C. for 60 min and then at 20° C. for a further 14 hours, and the polymerization was then terminated. The results for the PS—PPO block copolymer obtained were as follows: conversion 60%, polydispersity index PDI 1.4, number-average molar mass Mn 3100. A second GPC peak with about 50% of the integral was attributed to the PSLi.

### Example C7

a) 2.5 ml of styrene were added to 5.2 ml of toluene. 0.9 ml of the solution S13 (sBuLi) were added to this mixture, which was polymerized at 0° C. for 2 hours. The polystyrene block obtained (polystyryllithium, PSLi) had a polydispersity index PDI of 1.1 and a number-average molar mass Mn of 2200.

b) 2.5 ml of PO were added to 1 ml of the solution (PSLi) obtained in a). Once the color of the solution had changed, 4.77 ml of the solution S15 (EtAliBu₂) were added to the mixture, the Al/Li molar ratio thus being 5:1. The mixture was polymerized at 0° C. for 60 min, and the polymerization was then terminated. The results for the PS—PPO block copolymer obtained were as follows: conversion 99%, polydispersity index PDI 2.0, number-average molar mass Mn 4200. A second GPC peak with about 30% of the integral was attributed to the PSLi.

### Comparative Example Comp. 5

The procedure was as in Example C7, but 4.77 ml of the solution S16 (Et₂Zn) were used instead of solution S15 (EtAliBu₂). The polymerization was terminated after 48 hours. The results were as follows: conversion 0.5%; GPC analysis showed that no PPO block was formed in stage b) on the PS block.

### Comparative Example Comp. 6

The procedure was as in Example C7, but 4.77 ml of the solution S17 (Et₃B) were used instead of solution S15 (EtAliBU2). The polymerization was terminated after 48 hours. The results were as follows: conversion 0.5%; GPC analysis showed that no PPO block was formed in stage b) on the PS block.

The examples show that the process of the invention is a simple method for preparing either homo- or copolymers of oxiranes. The polymerization times are considerably shorter and, respectively, the molar masses Mn achieved are markedly higher than with the known processes: Example H1, 20 800 after 15 hours; Example H2, 15 100 after only 25 min; Example H7, 18 200 after 50 min; Example H10, 69 900 after 6 hours; and Example H11 22 600 after 60 min. This also applies to the copolymers: Example C1: 19 400 after 12 hours for the PS block and 70 min for the PPO block; Example C4, 30 800 after 2 hours (PS) plus 48 hours (PPO); Example C7 4200 after 2 hours (PS) plus 1 hour (PPO).

The comparative examples comp. 1 to comp. 6 show that when the organylaluminum compound is omitted no oxirane polymers are formed, and, respectively, that in comp. 3 the molar mass obtained, only 3400 even after 7 days of polymerization time, is very low.

We claim:

1. A process for preparing homopolymers of oxiranes, or for preparing copolymers of oxiranes and comonomers, via anionic polymerization in the presence of an alkali metal compound and of an organylaluminum compound, which comprises avoiding any use of crown ethers or of cryptands during the polymerization.

2. A process as claimed in claim 1, wherein the oxiranes have been selected from propylene oxide, ethylene oxide, and mixtures of these.

3. A process as claimed in claim 1, wherein the comonomers have been selected from styrene, α-methylstyrene, butadiene, isoprene, and mixtures of these.

4. A process as claimed in claim 1, wherein the alkali metal compound has been selected from alcoholates, hydrides, hydroxides, amides, carboxy compounds, aryl compounds, arylalkyl compounds, and alkyl compounds of the alkali metals, and mixtures of these.

5. A process as claimed in claim 1, wherein trialkylaluminum compounds are used as organylaluminum compound.

6. A process as claimed in claim 1, wherein the molar ratio of aluminum to alkali metal is from 1 to 100: 1.

7. A process as claimed in claim 1, wherein use is made of from 0.5 to 20 mol % of organylaluminum compound, calculated as aluminum atoms and based on the molar amount of the oxirane.

8. A process as claimed in claim 1, wherein the copolymers are block copolymers, sequential polymerization being used, first polymerizing the comonomer to give a polymer block B and then polymerizing the oxirane to give a polyoxirane block A.

9. A process as claimed in claim 1, wherein, at least during the polymerization of the polyoxirane block A, the molar ratio of aluminum to alkali metal is from 1:1 to 100:1.

10. A homopolymer of oxiranes, or a copolymer of oxiranes and comonomers, or a mixture of these, obtainable by the process as claimed in claim 1.

11. A copolymer as claimed in claim 10 which is a block copolymer.

12. The use of the homopolymers or copolymers as claimed in claim 11 for producing moldings, foils, fibers, or foams.

13. A molding, foil, fiber, or foam composed of the homopolymers or copolymers as claimed in claim 10 or 11.

14. A process as claimed in claim 2, wherein the comonomers have been selected from styrene, α-methylstyrene, butadiene, isoprene, and mixtures of these.

15. A process as claimed in claim 2, wherein the alkali metal compound has been selected from alcoholates, hydrides, hydroxides, amides, carboxy compounds, aryl compounds, arylalkyl compounds, and alkyl compounds of the alkali metals, and mixtures of these.

16. A process as claimed in claim 3, wherein the alkali metal compound has been selected from alcoholates, hydrides, hydroxides, amides, carboxy compounds, aryl compounds, arylalkyl compounds, and alkyl compounds of the alkali metals, and mixtures of these.

17. A process as claimed in claim 2, wherein the comonomers have been selected from styrene, α-methylstyrene, butadiene, isoprene and mixtures of these.

18. A process as claimed in claim 2, wherein trialkylaluminum compounds are used as organylaluminum compound.

19. A process as claimed in claim 3, wherein trialkylaluminum compounds are used as organylaluminum compound.

20. A process as claimed in claim 2, wherein the molar ratio of aluminum to alkali metal is from 1 to 100:1.
